(19) United States
(12) Patent Application Publication
(10) Pub. No.: US 2015/0052014 A1
(43) Pub. Date: Feb. 19, 2015

(54) METHODS AND SYSTEMS FOR PROVIDING UPDATED DATA VIA AN IMAGE

(71) Applicant: SV I LLC, Savannah, GA (US)

(72) Inventor: Michael Charles Patrick Mason, Savannah, GA (US)

(73) Assignee: SV I LLC, Savannah, GA (US)

(21) Appl. No.: 13/970,148

(22) Filed: Aug. 19, 2013

(51) Int. Cl. G06Q 30/06

(52) U.S. Cl. CPC G06Q 30/0613; G06Q 30/0643
USPC 705/26.41

(57) ABSTRACT

Systems and methods for providing updated data via an image. A sales manager system provides an advertisement image of a product for display on one of a plurality of third-party websites. A request is received for the advertisement image from a third-party system that provides a third-party website. Advertisement data is assembled, including product information, seller information, and third-party system information from information that is maintained by the sales manager system. A rendered advertisement image is rendered from the assembled data. The sales manager system also updates any maintained information thus incorporating it in any subsequent rendered advertisement image.

### TECHNICAL FIELD

This disclosure relates generally to providing updated data via an image and more particularly relates to a method and system for generating an updated image to provide updated data.

### BACKGROUND

There are many individual online sellers of products. These individuals may place their products for sale at various third-party sites that may be dedicated to a niche group of potential buyers. It is often to the advantage of an online seller to place products for sale on as many third-party sites as possible in order to maximize sales. However, given the number of third-party sites, it is difficult for an online seller to manage the sales at each site. To do so, the seller typically uses a cumbersome manual process to identify the sites, establish credibility, publish the item for sale at each site, check each site multiple times per day to compile sales, clicks, and to edit posts. Also, a seller may need to manually update the purchaser on the status of a sales transaction, such as informing the purchaser when payment is received, the product is shipped, etc. The more sites used to sell a product, the more sales; however, the more maintenance required by the seller at each third-party website. In addition, many of these sites do not accept any software code for a product advertisement, making it difficult for a seller to automate any of these maintenance tasks.

It would be beneficial to minimize the time required to manage the sale of products at various third-party websites. Accordingly, systems and methods are desirable for centrally managing the sale of products offered for sale at multiple third-party systems, where the systems do not accept software code from a seller. The systems and methods alternatively may be used in other situations where it is desirable to provide updated data to a system that does not accept software code.

### SUMMARY

Exemplary methods and systems are disclosed to provide updated data via an image. In particular, a central manager system creates and communicates images to various websites and centrally manages transactions and information associated with the images. The images include real-time data. The central manager system creates an updated image with updated information. An updated image may include updated information from any system in communication with the manager system. The updated image may be created at any time, including but not limited to upon request from any system in communication with the manager system. Relevant information received from a user of one website may be included both in an image on that website, as well as an image on another website.

One exemplary implementation may be used to sell a product on multiple websites. The image may include information about the product and the seller and may be tailored to the website where the image is displayed. Updated images may be created using data updated as purchases of the product are made regardless of which website the purchaser used to view the product. The updated data may include information about the status of the purchase, inventory information, and information about the seller or product, including feedback information. The feedback information may include portable ratings for one or more of the buyer, the seller, and the product. The updated images may be provided to the users of the websites through an automatic process so that the images appear to be dynamically updating even though only a static image is provided.

Implementations other than a sales implementation are also possible. For example, an image that displays data may be displayed on a website and may be replaced with an updated image with updated data. Alternatively, the image may be included in an e-mail or otherwise linked to a document.

These illustrative aspects and features are mentioned not to limit or define the invention, but to provide examples to aid understanding of the inventive concepts disclosed in this application. Other aspects, advantages, and features of the present invention will become apparent after review of the entire application.

### BRIEF DESCRIPTION OF THE FIGURES

These and other features, aspects, and advantages of the present disclosure are better understood when the following Detailed Description is read with reference to the accompanying drawings, where:

FIG. 1 is a diagram illustrating an environment configured to provide a sales manager system;

FIG. 2 is a diagram illustrating the information gathered when registering a product for sale at a sales manager system;

FIG. 3 is a diagram illustrating information accessed by the sales manager system to render an advertisement image of a product for display on one of a plurality of third-party websites;

FIG. 4 is a block diagram depicting an exemplary computing device for use in certain embodiments; and

FIG. 5 is a flow chart of an exemplary method of generating an advertisement image of a product for display on one of a plurality of third-party websites.

### DETAILED DESCRIPTION

Systems and methods are provided for rendering an image to automatically provide updated data where the data may be received from different systems and the image may be tailored for a particular website. One exemplary implementation may be used to offer a product for sale on multiple websites. The image may include information about the product and the seller and may be tailored to the website where the image is displayed. Different images may be created for different websites and the product may be offered for sale on multiple websites at the same time. Updated images may be created using data updated as purchases of the product are made regardless of which website the purchaser used to view the product. The central management of the data allows the portability of some of the data included in the image. The updated data may include information about the status of the purchase, such as payment information and shipping information, inventory information, and feedback/rating information about the seller, buyer, or product. An updated image may be provided in response to a subsequent request by the website so that the images appear to be dynamically updating even though only a static image is provided.

Implementations other than a sales implementation are also possible. For example, an image that displays data may be displayed on a website and an updated image with updated data may be created when new data becomes available. Note that the updated image may be created at any time, including but not limited to upon request from any website. Alternatively, the image may be included in an e-mail or otherwise linked to a document. Although reference is made to an “image” herein, it should be understood that the term includes multiple images, images that include animation, and any other type of image so long as it does not include executable code.

### Sales Implementation

Additional details about aspects of the invention will be provided with reference to a sales implementation where a seller uses a sales manager system to manage the sale inventory of a product offered for sale at multiple third-party websites. Even though each third-party website may have different requirements for users of their site, such as the seller, the sales manager system centrally administers the sale and inventory management of the product offered for sale at the third-party websites. For example, the seller registers the product with the sales manager system by providing information regarding the product, the seller, and the third-party websites where the product is to be offered for sale. Note that a user of a sales manager system may be a buyer or a seller. However, when a product registered by a user is advertised for sale, the user of the sales manager system that registered the product is a seller.

Using the information provided by the seller, the sales manager system may provide advertisement images of the product tailored for each third-party website. In one example, a seller wants to sell products, such as watches, on three different third-party websites, Website 1, Website 2, and Website 3. The websites may be any type of a website that allows users to post an image including, but not limited to, social media websites, forums, or blogs. Since each website may be directed towards a different audience, the sales manager system may provide three different advertisement images, each one tailored to a specific website. The ability to tailor the advertisement image for each third-party system allows the seller to customize the sale of the product depending on where it will be placed for sale. For example, the description and picture of the watch included in each advertisement image may be different to highlight features of the watch that appeal to viewers of a specific website. In addition, customization allows a seller to make different sales promotions to better appeal to the viewers of a specific third-party website. For example, on Website 1, the seller may offer the product for sale at a reduced price, whereas on Website 2, the seller may offer a price reduction if the purchaser buys two or more items. This feature allows the seller to make different offers while centrally administrating all sales using the sales manager system. In addition, as updates associated with the product for sale occur, such as sales, price changes, or feedback received on the product, the buyer, or the seller, the advertisement image provided to each third-party website is updated to reflect the most current information. The advertisement image is updated when the image is reloaded from the sales manager system so the update occurs even when the third-party website does not accept any code from the seller or the sales manager system.

The advertisement images are created using information entered by the seller upon registering a product for sale. A seller registers a product by logging on to the sales manager system, in some instances paying a subscription fee, and registering a product to be offered for sale at one or more third-party websites. Alternative ways of registering a product and/or entering the relevant information may also be used.

In an example implementation, the information entered by the seller can be classified as product information, third-party system information, and seller information. The product information the seller enters to register a product may include the name of the product, price, description, picture(s) or image(s) of the product, shipping cost, and other such information pertinent to the product. The same picture or image of the product may be used for multiple advertisement images or a picture or image may be used by only one advertisement image depending upon the seller's preference. The seller information includes any information needed to identify the seller of the product or any information that may be relevant to a potential buyer. This includes, but is not limited to, the name of the seller, email address, and any other information that can identify the seller, as well as the seller's ratings for all transactions in which the seller has been involved using the sales manager system. Note, that a seller may be identified by different names on different third-party websites. If so, then the seller may enter different seller names to be associated with the different third-party systems. Information regarding the third-party system includes any information needed to identify the third-party system and the third-party website where the product will be offered for sale. This information may include but is not limited to name, logo, site description, and web address. The third party system information may be stored by the sales manager system for future use by the system or its users.

Even though a seller may be known by different names on different third-party websites, the sales manager system allows a seller's feedback rating to follow the seller across the different websites by aggregating feedback information for the seller regardless of which website a purchaser used to view the advertisement image. The sales manager system may allow various options for the aggregation of feedback information, such as across a product or product type, or across all products offered by a seller.

The information a seller enters that is pertinent to the sale of a product or that the sales manager system receives from another source is organized and stored in logical groupings. Logical groupings may include but are not limited to information regarding the product, information regarding the seller, information regarding the advertisement images, information regarding the sales transactions, information regarding the buyer, information regarding the third-party systems, and information regarding feedback. This logical grouping of information may be implemented using a database, such as an SQL database. The information in the database may be stored and accessed through tables. Associated with each seller may be a set of tables created to store and access the different types of information. For example, the information regarding the product may be kept in a product table with a unique identifier for the product. The information regarding the third-party system may be kept in a third-party system table with a unique identifier for the third-party system. Likewise, the seller information may be kept in a seller table with a unique identifier for the seller. This model of storing information by the sales manager system allows centralized management of any information relating to the product or sale of the product, while also providing customized advertising of the product through advertisement images. Other ways of logically grouping information may be used and does not need to include the use of tables. However, different types of tables such as relational tables or object tables or any other types of tables may be used as will be apparent to those skilled in the art.

With information stored in a database, the sales manager system, may access the different tables and gather information needed to create an advertisement image. For example, an advertisement image requires third-party system information, product information, and seller information. The sales manager system creates queries using the unique identifiers to access information from the tables. For example, to create an advertisement image for product ABC to be sold at third-party system XYZ, the sales manager system may access the third-party system table with a query for the unique identifier for the third-party system XYZ. Information accessed from this table can include, but is not limited to, the name of the third-party system and the web address. The sales manager system also accesses the product table with the unique identifier for product ABC. The query may identify product information including but not limited to price, quantity available, description, picture of the product, etc. The sales manager system also queries the seller table with the unique identifier for the seller and obtains information about the seller including but not limited to name, as used on a particular third-party website and email address. The sales manager system may also query a feedback/ratings table with a unique identifier for the seller to obtain feedback information for the seller. Alternatively, the seller feedback information may be stored with the other seller information.

Once the third-party system information, product information, seller information, and feedback information is gathered, an advertisement image is created by rendering the gathered information into a static image file. The advertisement image may be of any file type, such as, but not limited to, a Joint Photographic Experts Group (JPEG) file, a Graphic Interchange Format (GIF) file, a Portable Network Graphic (PNG) file, or a Tagged Image (TIF) file.

The advertisement image for a particular third-party system is an image file without any executable code that is provided to the third-party system for display on their website. Most third-party systems allow sellers to provide a static image of the product for sale. The use of the advertisement image, as described herein, allows a seller to provide not only an image of the product, but also include real-time updated information about the product, the sale of the product, or the seller of the product without the use of any software code which is often precluded on third-party systems. The third-party systems handle the advertisement image provided by the sales manager system in a manner similar to other static images, but since the sales manager system can create a new image with updated information, the image appears to automatically update as new information becomes available.

Once an advertisement image is created, a unique image identifier is created and assigned to the advertisement image. In one implementation, a globally unique identifier referred to herein as an Ad Unique Identifier is used as the unique image identifier. Information for each advertisement image created is entered into an ad table with the Ad Unique Identifier used as the key. For example, an ad table may include, but is not limited to, the unique identifiers of the product, the seller, and the third-party system. The ad table provides a link between the advertisement image, the product, the seller and the third-party system. The sales manager system may use the Ad Unique Identifier to query the ad table to obtain the unique identifier of the product advertised by that particular advertisement image. With the unique identifier for the product, the product table can be queried and the specific product information can be located. Likewise, by querying the ad table with the Ad Unique Identifier, the unique identifier for the third-party system may be located, as well as the unique identifier for the seller of the product. Using the unique identifier for the third-party system, the respective table may be queried and information regarding the third-party system may be accessed. Similarly, with the unique identifier for the seller, the seller table may be queried and information regarding the seller may be accessed. Although this example references a table structure with a one-to-one data relationship, the sales manager system may use multiple data relationships, e.g., one-to-one, one-to-many, many-to-one, etc.

A potential purchaser of the product may find the product for sale at a third-party website that displays the advertisement image provided by the sales manager system. The potential buyer may view the advertisement image to gather information about the product or seller. To make a purchase, the potential buyer may select a link provided with the advertisement image or otherwise follow instructions provided by the advertisement image. In either situation, the potential purchaser may access a sales process administered by the sales manager system. Payment may be administered through a third-party payment system, such as the PAYPAL system or any such system providing the same or similar type of service. Communications between the sales manager system and the third-party payment system may include the unique image identifier for the advertisement image (e.g., Ad Unique Identifier) to enable the sales manager system to associate the payment with the correct sales transaction.

As the sales process proceeds, the sales manager system updates the product information. For example, a value representing the quantity of products sold may be kept in the product table and may be increased as additional products are sold or a value representing the quantity of products available for sale may be decreased as products are sold. The point in the sales process where the value is adjusted may vary in different systems. In some systems the value may be adjusted once payment is verified in which case the adjustment is based on information from the payment system, whereas in other systems the value may be adjusted once the product is shipped in which case the adjustment is based on information from the seller. The sales manager system may also maintain other types of data, such as the quantity of products sold on each website, the quantity of products sold within a certain period of time, etc.

This feature of updating information on the sale of a product by the sales manager system allows the centralized management of a product offered for sale at multiple third-party websites. Since the information regarding a product is centrally stored and updated by the sales manager system, any change in this information can be easily distributed to any one or all of the third-party systems. Once information is updated in any of the tables managed by the sales manager system, this updated information may be reflected in any subsequent advertisement image rendered. For example, if a sale of a product was made by a purchaser at a third-party site, the product information is updated so that the next rendered advertisement image for any third-party system reflects the sale of the product, as well as other information related to the website used to purchase the product and the buyer of the product.

In addition to centrally managing sales of a product, the sales management system may also include a feedback rating system. For example, once a purchaser buys a product advertised on a third-party website, the feedback rating system may request feedback from the purchaser. This request may be made through email or through a dialogue box presented to the purchaser. The feedback rating system may request feedback from the purchaser regarding any aspect of the sale, including but not limited to, the product, the price, the seller, the sales transaction, or any other information that potential purchasers or the seller may be interested in knowing. The feedback information may be associated with the unique image identifier (e.g., Ad Unique Identifier). The sales manager system can then update any corresponding information regarding the product, third-party system, or seller using the Ad Unique Identifier to access the ad table. For example, if the feedback information contains a rating for a particular product, the sales manager system may query the ad table with the Ad Unique Identifier and access the unique identifier for the product. With the unique identifier for the product, the sales manager system may access the product table and update the rating information kept in the product table. Note that feedback information from any sale at any third-party system is reflected on any subsequent advertisement image rendered. For example, if a Seller 1 receives a good rating for prompt shipment of product X sold through Website 1, then that good rating will be displayed in any subsequently rendered advertisement image for product X provided to any of the third-party systems. Likewise, the rating system for a product may be portable across third-party systems. If product X is sold through Website 1 and receives a positive rating, that rating is also shown when a subsequent advertisement image for product X is provided to any of the third-party sites. In essence, because the feedback information is centrally located and updated, the rating of sellers and products is portable and may be displayed anywhere the advertisement image is displayed, including, but not limited to, the third-party sites.

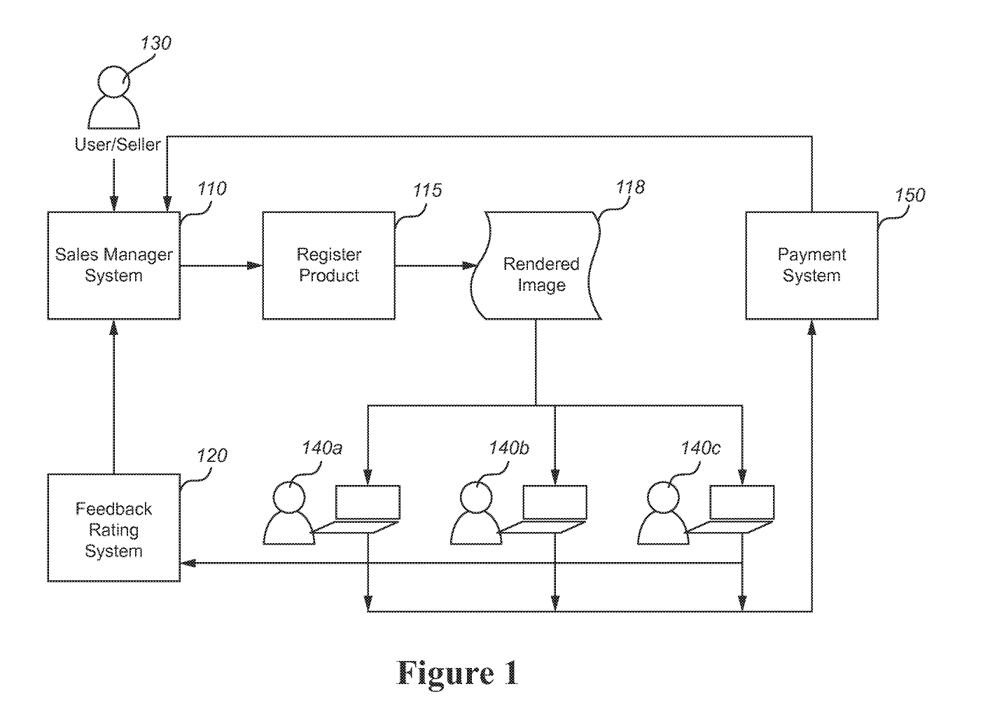

The present invention will now be described with reference to the accompanying drawings, in which exemplary implementations of the invention are shown. FIG. 1 is a diagram of the operating environment of a sales manager system 110. A seller 130 logs on to register a product for sale. In this example, the seller interfaces with the sales manager system, possibly through a menu, to enter information regarding the product, the seller, and the third-party systems where the product is to be offered for sale. The sales manager system 110 receives this information and registers the product at 115. Once the product is registered, the sales manager system may render an advertisement image for the product at 118. There may be multiple advertisement images rendered, one tailored for each third-party system specified. For example, a seller may be known by different names at different websites so the advertisement image for one third-party system may contain a different seller name than the advertisement image for the same product for a different third-party system. Likewise, the seller may want to offer the product at different prices depending on where the product is to be sold. Therefore, different advertisement images for the same product for different third-party systems may display different prices.

Referring to FIG. 1, a specific advertisement image is provided to a specific third-party system and is displayed on the third-party website, which may be viewed by multiple users 140A, 140B, and 140C. Although not shown in FIG. 1, the sales manager system may also provide a different advertisement image to a different third-party system. Once a purchase is initiated by any of the users 140A, 140B, or 140C, the sales manager system provides a sales process. Portions of the sales process may be provided by or use other systems. For example, payment may be handled through a payment system 150 such as the PAYPAL system or any other payment system. The sales manager system 110 updates the product information, third-party system information, and/or seller information with information about the purchase, feedback or other relevant aspects of the sale as the sales process proceeds. Any subsequent advertisement image requested or rendered for any third-party system will include the most up-to-date information.

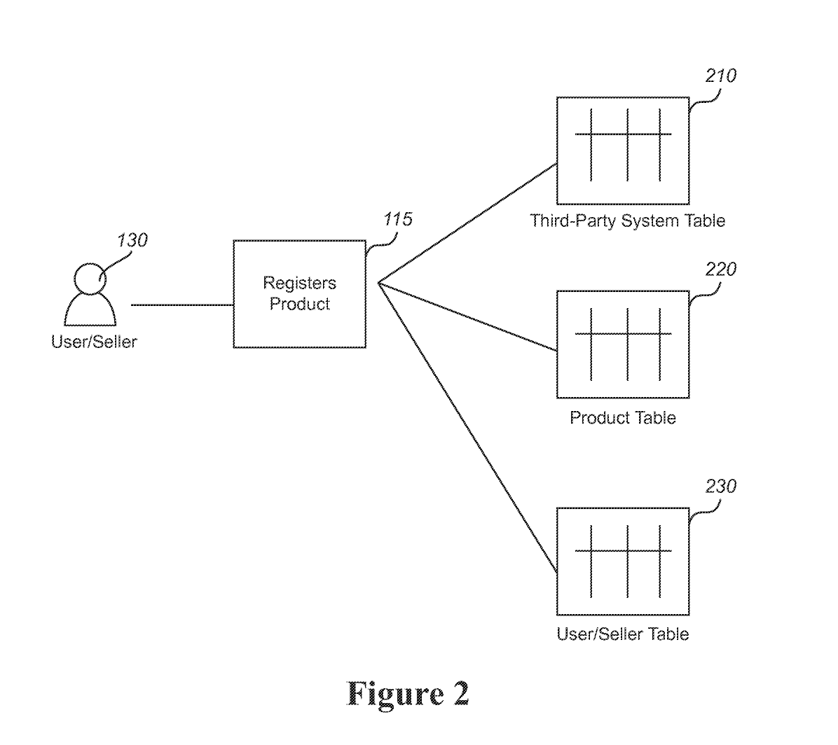

As shown in the example of FIG. 2, when the product is registered at 115, the sales manager system logically groups the information entered by creating a database, such as a SQL database. In this example, tables may be created to store and access information entered by the seller. Several tables may be created including, but not limited to, a third-party system table 210, a product table 220, and a seller table 230. The third-party system table 210 may contain a unique identifier for each third-party system along with information regarding each third-party system, such as name and web address. The product table 220 may contain a unique identifier for the product along with product specific information such as product name, price, picture, description, etc. The seller table 230 may contain a unique identifier for the seller along with information about the seller including any names and email addresses. As noted above, other other ways of logically grouping the information and of creating relationships between the information may be used in other implementations.

Referring back to FIG. 1, the sales manager system 110 may receive information associated with the unique image identifier for the advertisement image (e.g., Ad Unique Identifier) from the payment system 150, the seller 130, or the feedback rating system 120, and may update information in a product table 220, third-party system table 210, or seller table 230. For example, the payment system 150 communicates transaction information to the sales manager system that includes the Ad Unique Identifier and the sales manager system uses the Ad Unique Identifier to update information in the product table 220 or other table. In one implementation the Ad Unique Identifier is used to query the ad table in order to obtain the unique identifier for the product, which is used to update information in the product table 220.

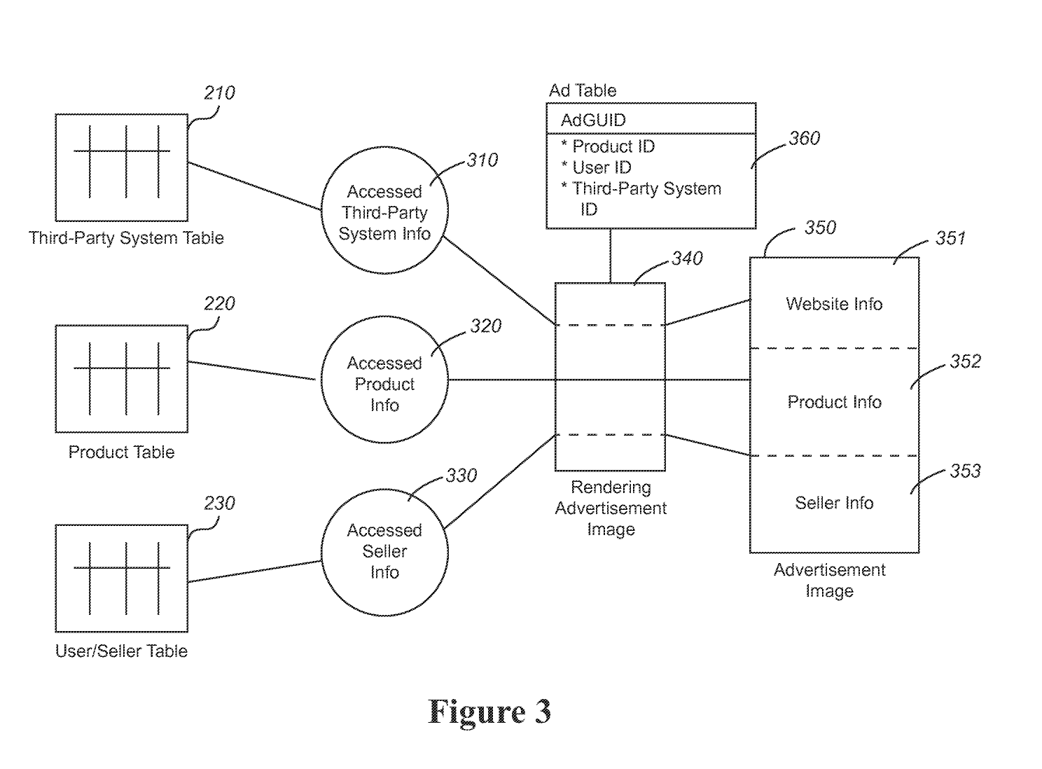

Referring to FIG. 3, the sales manager system accesses information in the tables to create an advertisement image. The sales manager system 110 may receive a request from a seller to create an advertisement image for a product to be sold at a third-party system or a third-party system may request the image. The sales manager system accesses the third-party system table 210 to access information about the third-party system to include in the advertisement image at 310. Likewise, the sales manager system queries the product table 220 to access product information at 320 to include in the advertisement image. In addition, the sales manager system may also access the seller table 230 to obtain seller information at 330 and the buyer table 240 to obtain buyer information at 331 to include in the advertisement image. The information assembled from these tables is included in the rendered advertisement image at 340. The advertisement image may be formatted as shown at 350 with website information in a first section of the image 351, such as the name of the website and the website address, product information in a second section of the image 352, such as a picture of the product, a description of the product, and information about sales of the product, seller information 353 in a third section of the image, such as the name used by the seller on the website and seller feedback information, and buyer information 354 in a fourth section of the image, such as the name used by the buyer on the website and buyer feedback information. Other formats for the advertisement image are also supported. The format may be based, at least in part, on the specific third-party website where the advertisement image is to be displayed. The sales manager system maintains an ad table 360 with information about each rendered advertisement image. The ad table may contain, but is not limited to, the unique image identifier for the ad image (e.g., Ad Unique Identifier), the product identifier, the seller identifier, the buyer identifier, and the third-party system identifier.

The ad table 360 creates an association between the advertisement image created and the third-party system, the product for sale, the seller selling the product, and the buyer(s) purchasing the product. The unique image identifier may be used as a key to the ad table, i.e., to create a relationship or association between different types of information. The product identifier, the third-party system identifier, the seller identifier, and the buyer identifier(s) may be kept in the ad table 360 and associated with the unique image identifier for the advertisement image. Hence, the unique image identifier may be used to query the ad table to determine the identifiers of the product, the third-party system, the seller and/or the buyer(s) associated with that advertisement image. Also, by determining the identifiers of the product, third-party system, seller, and buyer, queries into the third-party system table 210, the product table 220, the seller table 230, and the buyer table 240 may be made to access other information as needed.

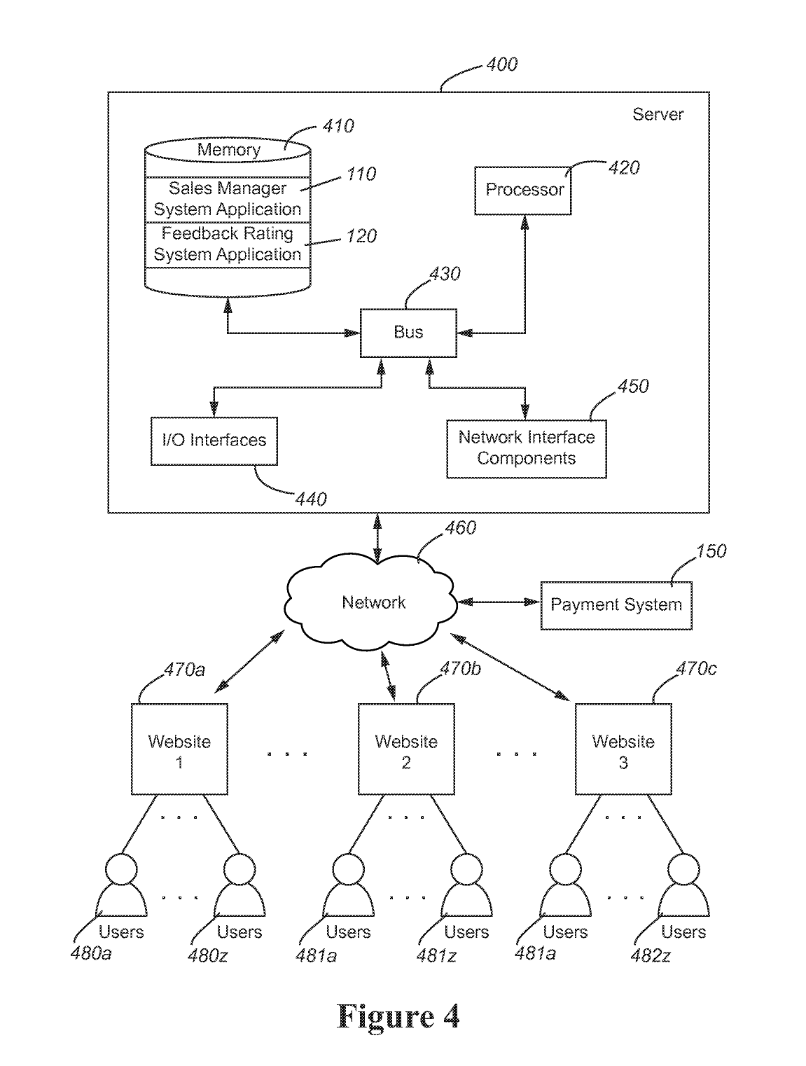

FIG. 4 depicts an exemplary operating environment in which the sales manager system 112 may be utilized. The methods and systems disclosed herein are also applicable on other computing systems and environments.

The environment shown in FIG. 4 comprises a server 400 used as a special purpose computing device to provide specific functionality associated with the sales manager system application 110 and the feedback rating system application 120. As is known to one of skill in the art, applications such as the sales manager system 110 and the feedback rating system 120 may be resident on any suitable computer-readable medium and execute on any suitable processor. For example, as shown, the server 400 comprises a computer readable medium such as memory 410, coupled to a processor 420 that executes the computer-executable program instructions and/or accesses information stored in memory 410. Such a processor may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described therein. The memory 410 may also store the product information, seller information, website information, and any other information needed to create advertisement images.

A computer-readable medium may comprise, but is not limited to, an electronic, optical, magnetic, or other storage device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

A server 400 may also comprise functionality, such as I/O interfaces 440 for connecting to a number of external or internal devices such as a mouse, a CD-ROM, DVD, a keyboard, a display, audio speakers, or other input or output devices. A bus, such as bus 430, is typically included in the server as well. Server 400 is connected to a network 460. Through the network 460, the sales manager system 110 communicates with multiple third-party systems 470a, 470b, and 470c. These third-party systems may be running applications on servers (not shown) to provide Website 1, Website 2 and Website 3. There may be multiple users accessing each third-party system such as users 480a-480z at third-party system 470a, users 481a-481z at third-party system 470b, and users 482a-482z at third-party system 470c. The server may also interface with a separate system, such as a payment system 150 via the network 460.

The advertisement image created by server 400 may be posted on one of the third-party system's websites by the seller. When a website user views the website, the server receives a request for the advertisement image and in response, creates the advertisement image using the most up-to-date data and provides the advertisement image via network 460.

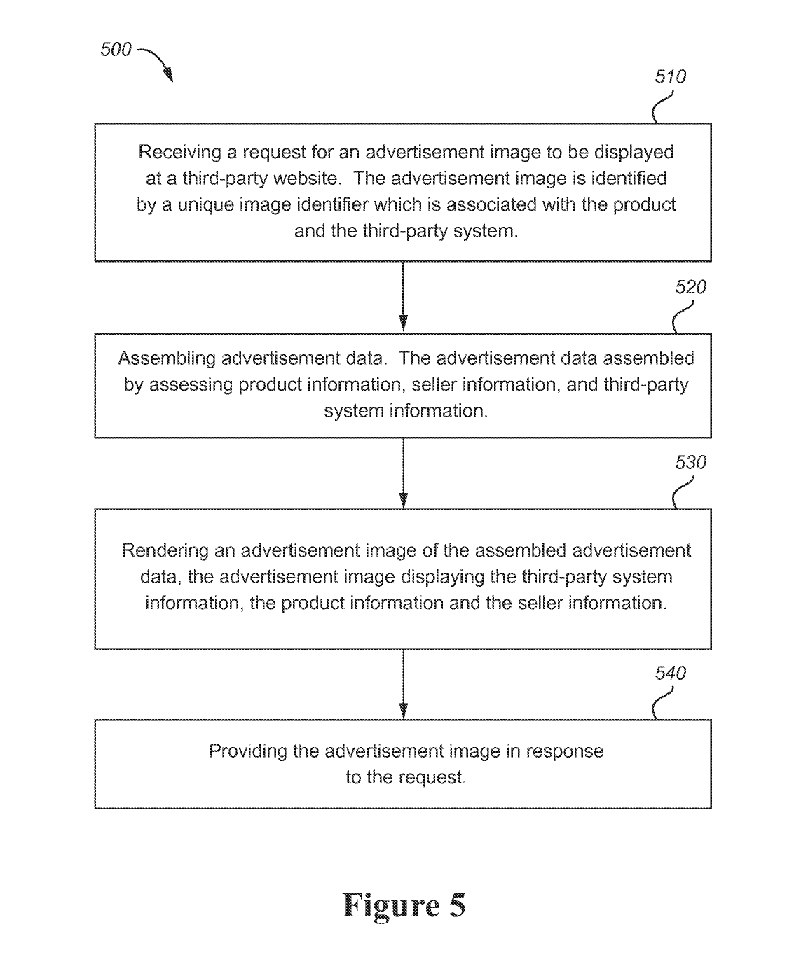

FIG. 5 is a flow chart of an exemplary method 500 for generating an advertisement image of a product for display on a third-party website that includes updated data. The exemplary method includes receiving a request for an advertisement image from a third-party system that provides a third-party website. The request includes a unique image identifier, which is associated with the product, the seller, and the third-party system at block 510.

The exemplary method 500 further comprises assembling advertisement data by the sales manager system. The advertisement data is assembled by accessing product information and seller information associated with the product, and third-party system information associated with the third-party website at block 520. In one example, the sales manager system creates database tables containing product information, seller information, and third-party system information. Each of these tables may be accessed using a corresponding key which may consist of a unique identifier. For example, the product table may be queried using the identifier of the product.

The exemplary method 500 further comprises rendering an advertisement image of the assembled advertisement data at block 530. The advertisement image may display different types of information in different sections of the image. For example, one section may display the third-party system information, another section may display the product information, and yet another section may display the seller information. The rendered image contains no executable code so it is acceptable to third-party systems that do not accept a file containing executable code. The exemplary method 500 further comprises providing the advertisement image in response to the request at block 540. Although not shown in FIG. 5, the unique image identifier may also be associated with a buyer. If so, then buyer information is accessed and included in the assembled advertisement data and the advertisement image includes a section for the buyer information.

Since the advertisement image is a digital image file, it can be posted anywhere that accepts digital image files, including but not limited to websites and emails. If an advertisement image is included in an email sent to a recipient, then each time the recipient opens the email, the advertisement image is displayed in the email with the most up-to-date information. For example, if the sales manager system has updated any information in any of its tables since the last time the e-mail was opened, then a different advertisement image is rendered with the updated information.

Although the invention has been described in connection with the sale of a product, the invention is not limited to on-line sales and may be used in any other implementation where it would be useful to provide updated data via a static image. Depending upon the implementation, the type of data that is maintained and displayed in the image may be different. For example, instead of product information, a central manager system may maintain information related to a particular subject matter or topic and instead of seller information, a central manager system may maintain information on the source or provider of the image. In addition, the invention is not limited to using the specific tables and identifiers described herein, but can use any means for creating an association among different types of information or data. The types of data, the logical grouping of the data, and the association between data may also differ in other systems.

### General Considerations

Numerous specific details are set forth herein to provide a thorough understanding of the claimed subject matter. However, those skilled in the art will understand that the claimed subject matter may be practiced without these specific details. In other instances, methods, apparatuses or systems that may be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Examples of the methods disclosed herein may be performed in the operation of such computing devices. The order of the blocks presented in the examples above can be varied, for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform addition tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering include herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. For example, although the invention has been described using the example of selling a product via multiple website, the invention is applicable to any use of a centralized system to create an image that provides updated data. Accordingly, it should be understood that the present disclosure has been presented for purposes of example rather than limitation, and does not preclude inclusion of such modification, variations and/or additions to the present subject matter as may be readily apparent to one of ordinary skill in the art.

1. A method for generating an image for display on one of a plurality of third-party websites, comprising:
receiving a request for the image from a first third-party system that provides a first third-party website, wherein the request includes a unique image identifier;
assembling image data by a sales manager system that is distinct from the first third-party system by accessing product information and seller information associated with the product and third-party system information associated with the first third-party system, wherein the sales manager system maintains the product information, seller information, and third-party system information and the sales manager system creates an association between the product information, seller information, and third-party system information;
rendering the image, wherein the rendered image includes the assembled image data, including the product information, the seller information, and the third-party system information; and
providing the rendered image in response to the request.

2. The method for generating an image for display on one of a plurality of third-party websites as in claim 1, wherein the product information associated with the unique image identifier is updated by the sales manager system in response to receiving payment processing information associated with the unique image identifier from a system distinct from the sales manager system and the first third-party system.

3. The method for generating an image for display on one of a plurality of third-party websites as in claim 1, further comprising:
receiving a subsequent request for the image from the first third-party system, wherein the subsequent request includes the unique image identifier;
assembling updated image data by the sales manager system by accessing updated product information, wherein the updated product information is maintained by the sales manager system;
rendering the updated image, wherein the rendered updated image includes the assembled updated image data; and
providing the rendered updated image in response to the subsequent request.

4. The method for generating an image for display on one of a plurality of third-party websites as in claim 1, further comprising:
receiving feedback information on a seller of the product that is collected in connection with purchases of the product initiated from the first third party website and purchases of the product initiated from a second third party website; and
updating the seller information with the feedback information so that a subsequent rendered image reflects the feedback information from purchases of the product initiated from the first third party website and purchases of the product initiated from the second third party website

5. The method for generating an image for display on one of a plurality of third-party websites as in claim 1, further comprising:
receiving a purchase request for the product from a user of a second third-party system that is distinct from the sales manager system and the first third-party system; and
updating the product information so that a subsequent rendered image reflects the purchase request from the user of the second third-party system.

6. The method for generating an image for display on one of a plurality of third-party websites as in claim 1, wherein rendering the image comprises rendering the image as a Joint Photographic Experts Group (JPEG) file, a Graphic Interchange Format (GIF) file, a Portable Network Graphic (PNG) file, or a Tagged Image (TIF) file.

7. The method for generating an image for display on one of a plurality of third-party websites as in claim 1, wherein seller information comprises a first seller name specific to the first third-party system and a second seller name specific to a second third-party system.

8. A server configured to generate an image for display on a plurality of third-party websites, comprising:
a processor;
interfaces for connecting with an external network to communicate with a plurality of third party systems;
a storage medium comprising:
data representing product information, seller information, and third party website information, wherein the product information reflects information received from a user of each of the plurality of third-party websites; and
instructions executable by the processor for:
receiving a request for the image identified by a unique image identifier from a first third-party system;
assembling data for presentation in the image by compiling the data representing product information, seller information, and third party website information;
creating a rendered image, wherein the rendered image includes the data for presentation in the image;
providing the rendered image in response to the request;
receiving a subsequent request for the image identified by the unique image identifier from the first third party system;
assembling updated data for presentation in an updated image by compiling updated product information;
creating a second rendered image, wherein the second rendered image includes the updated data for presentation in the updated image; and
providing the second rendered image in response to the request.

9. The server as in claim 8, wherein the storage medium further comprises instructions executable by the processor for:
prompting users of the plurality of third-party systems that purchased a product described in the rendered image or the second rendered image for feedback information for the seller or the product,
wherein assembling updated data for presentation in an updated image includes compiling the feedback information.

10. The server as in claim 8, wherein the image advertises a product for sale and the storage medium further comprises instructions executable by the processor for centrally administering a sales process for the product.

11. The server as in claim 8, wherein the storage medium further comprises instructions executable by the processor for:
receiving a request for a second image identified by a second unique image identifier from a second third-party system;
assembling data for presentation in the second image by compiling the data representing product information, seller information, and second third party website information, wherein the seller information in the image and the second image is the same; and
creating a rendered second image, wherein the rendered second image includes the data for presentation in the second image.

12. A method for providing updated data via an image, wherein the image is tailored for display on a first third party website, comprising:
maintaining, by a manager system, data related to a topic by storing the data in at least one database, updating the data as new data is received, and associating the data with the image, wherein some of the data is received from a third-party system distinct from the manager system;
maintaining, by the manager system, website data related to a first third party website or a first third party system that provides the first third party website by storing the website data in at least one database and associating the website data with the image;
receiving, by the manager system, a request for the image identified by a unique image identifier from the first third-party system;
assembling, by the manager system, data for presentation in the image by compiling the data related to the topic and the website data;
creating, by the manager system, a rendered image, wherein the rendered image includes the data for presentation in the image;
providing, by the manager system, the rendered image in response to the request;
receiving, by the manager system, a subsequent request for the image identified by the unique image identifier from the first third-party system;
assembling, by the manager system, updated data for presentation in an updated image by compiling updated data related to the topic and the website data;
creating, by the manager system, a second rendered image, wherein the second rendered image includes the updated data for presentation in the updated image; and
providing, by the manager system, the second rendered image in response to the request.

13. The method as in claim 12, wherein the image is related to a product that is offered for sale and the data related to the topic includes feedback information on a seller of the product that is collected in connection with purchases of the product initiated from the first third party website and purchases of the product initiated from a second third party website.

14. The method as in claim 12, wherein the image is related to a product that is offered for sale and the data related to the topic includes inventory information that reflects purchases of the product initiated from the first third party website and purchases of the product initiated from a second third party website.

15. The method as in claim 12, wherein associating the data with the image and associating the website data with the image comprises associating the unique image identifier with an identifier for the data and an identifier for the website data.

16. The method as in claim 12, further comprising:
maintaining, by the manager system, additional website data related to a second third party website or a second third party system that provides the second third party website by storing the additional website data in at least one database and associating the additional website data with a second image;
receiving, by the manager system, a request for the second image identified by a second unique image identifier from a second third-party system, wherein the image and the second image are both directed to the topic;
assembling, by the manager system, data for presentation in the second image by compiling the data related to the topic and the additional website data, wherein the data related to the topic for the second image is the same as the data related to the topic for the image;
creating, by the manager system, a rendered second image, wherein the rendered second image includes the data for presentation in the second image; and
providing, by the manager system, the rendered image in response to the request.
